(19) United States
(12) Patent Application Publication
(10) Pub. No.: US 2007/0077055 A1
(43) Pub. Date: Apr. 5, 2007

(54) Image taking apparatus and program for multiple-exposure shooting

(75) Inventors: Ryuichiro Tominaga, Higashiosaka (JP); Yukio Mori, Hirakata (JP); Seiji Okada, Hirakata (JP); Yasuhachi Hamamoto, Moriguchi (JP); Masahiro Yokohata, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Moriguchi (JP)

(21) Appl. No.: 11/527,386

(22) Filed: Sep. 27, 2006

(30) Foreign Application Priority Data
Sep. 30, 2005 (JP) JP2005-287820

(51) Int. Cl. G03B 7/10

(52) U.S. Cl. 396/256

(57) ABSTRACT

The exposure time calculator calculates exposure time of image sensor based on an aperture value corresponding to a diaphragm and brightness of an object. The predetermined time calculator calculates predetermined time based on a focal length of a lens and a predetermined coefficient. The shooting mode determining unit determines execution of multiple-exposure shooting to obtain a composite image of the object by obtaining multiple object images and then combining the multiple object images in a case where the exposure time is equal to or longer than the predetermined time. The motion detector detects motion among the multiple object images in the multiple-exposure shooting. The predetermined coefficient calculator updates a predetermined coefficient based on the detected amount of motion.

### CROSS REFERENCE TO RELATED APPLICATIONS

This application is based upon and claims the benefit of priority from Japanese Patent Application No. 2005-287820 filed on Sep. 30, 2005, the entire contents of which are incorporated herein by reference.

### BACKGROUND OF THE INVENTION

1. Field of the Invention

The present invention relates to an image taking apparatus and a program for obtaining an object image and to perform multiple-exposure shooting by use of the object image.

2. Description of Related Art

In a conventional image taking apparatus such as a digital still camera, there has been known a technique to increase a shutter speed to prevent a camera shake at the time of image shooting, or in other words, to shorten exposure time of image sensor. To be specific, to prevent a camera shake at the time of image shooting, it is preferable to set the exposure time equal to or below 1/f second in a case where a focal length of a lens is set to f mm.

Moreover, in order to shoot an object in an appropriate exposure condition, this image taking apparatus is controlled as shown in FIG. 1A such that a diaphragm is closed and the exposure time is reduced in a case where the object has high brightness and that the diaphragm is opened and the exposure time is extended when the object has low brightness. In theses cases, the exposure time controlled so as to shoot the object in the appropriate exposure condition (this exposure time will be hereinafter referred to as optimal exposure time Tc) may be equal to or longer than 1/f second. Accordingly, to prevent a camera shake at the time of image shooting, countermeasures such as fixing a camera by use of a tripod or increasing the brightness of the object by use of a flash lamp may often take place.

A user of an image taking apparatus, however, does not always have a tripod. Meanwhile, battery power would soon run out when using a flash lamp frequently and the flash lamp would not be effective for shooting a distant object.

To solve these problems, Japanese Unexamined Patent Publication No. 2000-69352 discloses an image taking apparatus for preventing a camera shake by performing multiple-exposure shooting.

The multiple-exposure shooting is a technique designed to obtain multiple images of an object by shooting at shorter exposure time than the optimal exposure time Tc and to obtain a composite object image by combining the multiple object images.

In the multiple-exposure shooting, as shown in FIG. 1B, it is possible to prevent a camera shake at the time of image shooting because of short exposure time required for taking each object image. Moreover, in the multiple-exposure shooting, although brightness of each object image is reduced due to the short exposure time, it is possible to obtain a bright composite image with a small influence of a camera shake by combining the multiple object images.

An example of an operation of such an image taking apparatus will be described with reference to FIG. 2. As shown in FIG. 2, in Step S401, the image taking apparatus calculates the optimal exposure time Tc based on an aperture value corresponding to the diaphragm and on the brightness of the object.

In Step S402, in a case where a focal length f of a lens is set equal to f mm, the image taking apparatus determines whether single shooting is performed or multiple-exposure shooting is performed based on 1/f second as a benchmark.

To be more specific, in a case where the optimal exposure time Tc is shorter than 1/f second, the image taking apparatus determines to perform the single shooting and the operation proceeds to Step S403. In a case where the optimal exposure time Tc is equal to or longer than 1/f second, the image taking apparatus determines to perform the multiple-exposure shooting and the operation proceeds to Step S404.

As shown in FIG. 3, for example, in a case where a focal length f of a lens is 30 mm when measured with 35 mm conversion, the benchmark is 1/30 second. Accordingly, in a case where the optimal exposure time Tc is shorter than 1/30 second, the image taking apparatus determines to perform the single shooting. In a case where the optimal exposure time Tc is equal to or longer than 1/30 second, the image taking apparatus determines to perform the multiple-exposure shooting.

In Step S403, the image taking apparatus performs the single shooting. Here, the single shooting means an operation to obtain a single object image taken at the optimal exposure time Tc.

In Step S404, the image taking apparatus calculates single shot exposure time T1 necessary for obtaining a single shot of the object image in the multiple-exposure shooting. To be more specific, the single shot exposure time T1 is preferably set equal to or longer than ⅛ of the optimal exposure time Tc and equal to or shorter than the optimal exposure time Tc.

In Step S405, the image taking apparatus calculates a composite number n of the multiple object images necessary for obtaining a composite image in the multiple-exposure shooting. To be more specific, the composite number n is calculated by use of “composite number n=optimum exposure time Tc/single shot exposure time T1.”

In Step S406, the image taking apparatus calculates total shooting time To necessary for obtaining the multiple object images in the multiple-exposure shooting. To be more specific, the total shooting time To is calculated by use of “total shooting time To=single shot exposure time T1 ×composite number n” and is equal to the optimal exposure time Tc.

In Step S407, the image taking apparatus performs the multiple-exposure shooting in accordance with the single exposure time T1, the composite number n, and the total shooting time To calculated in Steps S404 to S406.

In the case where the focal length f of the lens is equal to f mm, however, the above-described image taking apparatus determines whether the single shooting is performed or the multiple-exposure shooting is performed based on 1/f second as the benchmark. Accordingly, the benchmark is uniquely calculated in the case where the focal length f is equal.

Thus, in the case where the optimal exposure time Tc is shorter than 1/f second, the conventional image taking apparatus cannot perform the multiple-exposure shooting even in a case where a user of the conventional image taking apparatus is highly likely to cause a camera shake at the optimal exposure time Tc. Accordingly, the conventional image taking apparatus cannot prevent a camera shake in this case.

Moreover, in the above-described image taking apparatus, a frame period is not taken into consideration in the multiple-exposure shooting. Thus, the total shooting time To is extended in the case where the single shooting time T1 is shorter than the frame period. Accordingly, there has been a problem where a camera shake cannot be prevented in this case.

### SUMMARY OF THE INVENTION

A first aspect of the present invention is to provide an image taking apparatus performing a multiple-exposure shooting by using object images, the image taking apparatus that includes a lens, a diaphragm, an image sensor obtaining object images through the lens and the diaphragm, an exposure time calculator calculating exposure time of the image sensor based on an aperture value corresponding to the diaphragm and on brightness of the object, a predetermined time calculator calculating predetermined time based on a focal length of the lens and a predetermined coefficient, a shooting mode determining unit determining execution of the multiple-exposure shooting to obtain a composite image of the object if the exposure time is equal to or longer than the predetermined time, the composite image obtained to combine the plurality of object images, a motion detector detecting motion among the plurality of object images in the multiple-exposure shooting, and a predetermined coefficient calculator updating the predetermined coefficient based on the detected amount of motion.

According to this aspect, it is possible to change a benchmark, i.e. the predetermined time for switching the single shooting to the multiple-exposure shooting based on the motion among the multiple object images due to camera shake. It is, therefore, possible to switch the single shooting to the multiple-exposure shooting flexibly depending on occurrence of a camera shake.

In the first aspect of the present invention, the image taking apparatus may further include a multiple-exposure shooting controller configured to calculate single shot exposure time necessary for obtaining one object image, a composite number of the multiple object images necessary for obtaining the composite image, and total shooting time necessary for obtaining the multiple object image based on the exposure time and the predetermined time in the multiple-exposure shooting.

In the first aspect of the present invention, the multiple-exposure shooting controller may be configured to calculate an upper limit value of the composite number by use of an evaluated value indicating a correction effect of motion and to calculate the composite number based on the upper limit value.

According to this feature, it is possible to restrict the composite number by calculating the upper limit value of the composite number. It is, therefore, possible to prevent degradation of image quality of the composite image attributable to an increase in the composite number.

In the first aspect of the present invention, the multiple-exposure shooting controller may be configured to calculate the total shooting time based on a frame period in a case where the single shot exposure time is shorter than the frame period.

In the first aspect of the present invention, the multiple-exposure shooting controller may be configured to extend the single shot exposure time in a case where the single shot exposure time is shorter than the frame period and the total shooting time calculated based on the frame period is longer than the exposure time, and to calculate the composite number and the total shooting time based on the single shot exposure time.

According to this feature, even in the case where the single shot exposure time is shorter than the frame period in the multiple-exposure shooting, the single shot exposure time is calculated to be not too long so as to suppress the total shooting time. In this way, it is possible to prevent a camera shake attributable to the long single shot exposure time.

In the first aspect of the present invention, the multiple-exposure shooting controller may be configured to define the exposure time as the total shooting time in the case where the single shot exposure time is shorter than the frame period and the total shooting time calculated based on the frame period is longer than the exposure time, and to calculate the single shot exposure time and the composite number based on the total shooting time.

According to this feature, it is possible to suppress the total shooting time in the multiple-exposure shooting even in the case where the single shot exposure time is shorter than the frame period. In this way, it is possible to prevent a camera shake attributable to the long total shooting time.

A second aspect of the present invention provides a program configured to obtain an object image by use of image sensor exposed through a lens and a diaphragm and to perform a multiple-exposure shooting by use of the object image, the program causing a computer to execute procedures for calculating exposure time of the image sensor based on an aperture value corresponding to the diaphragm and on brightness of the object, calculating predetermined time based on a focal length of the lens and a predetermined coefficient, determining execution of the multiple-exposure shooting to obtain a composite image of the object if the exposure time is equal to or longer than the predetermined time, said composite image obtained to combine the plurality of object images, detecting motion among the plurality of object images in the multiple-exposure shooting, and updating the predetermined coefficient based on a detected amount of motion.

### BRIEF DESCRIPTION OF THE DRAWINGS

FIGS. 1A and 1B are diagrams for explaining single shooting and multiple-exposure shooting with a conventional image taking apparatus.

FIG. 2 is a flowchart showing an operation for causing the conventional image taking apparatus to perform the single shooting or the multiple-exposure shooting.

FIG. 3 is a diagram for explaining a criterion applicable to the conventional image taking apparatus for determining to perform the single shooting or the multiple-exposure shooting.

FIG. 4 is a block diagram showing a configuration of an image taking apparatus according to an embodiment of the present invention.

FIGS. 5A to 5D are diagrams showing an example of a camera shake limit value storage unit according to the embodiment of the present invention.

FIGS. 6A to 6C are diagrams for explaining detection of motion in the image taking apparatus according to the embodiment of the present invention.

FIG. 7 is a flowchart for explaining an operation for causing the image taking apparatus according to the embodiment of the present invention to perform the single shooting or the multiple-exposure shooting.

FIG. 8 is a flowchart showing a suppression process for total shooting time according to the embodiment of the present invention.

FIG. 9 is a flowchart showing a calculation process for a camera shake limit value according to the embodiment of the present invention.

FIGS. 10A and 10B are diagrams for explaining the multiple-exposure shooting by use of the conventional image taking apparatus.

FIGS. 11A and 11B are diagrams for explaining the multiple-exposure shooting by use of the image taking apparatus according to the embodiment of the present invention.

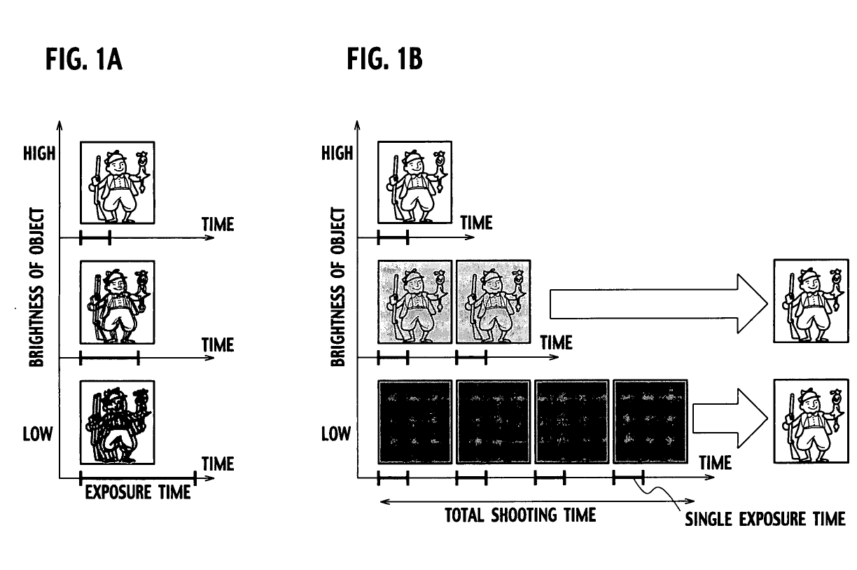

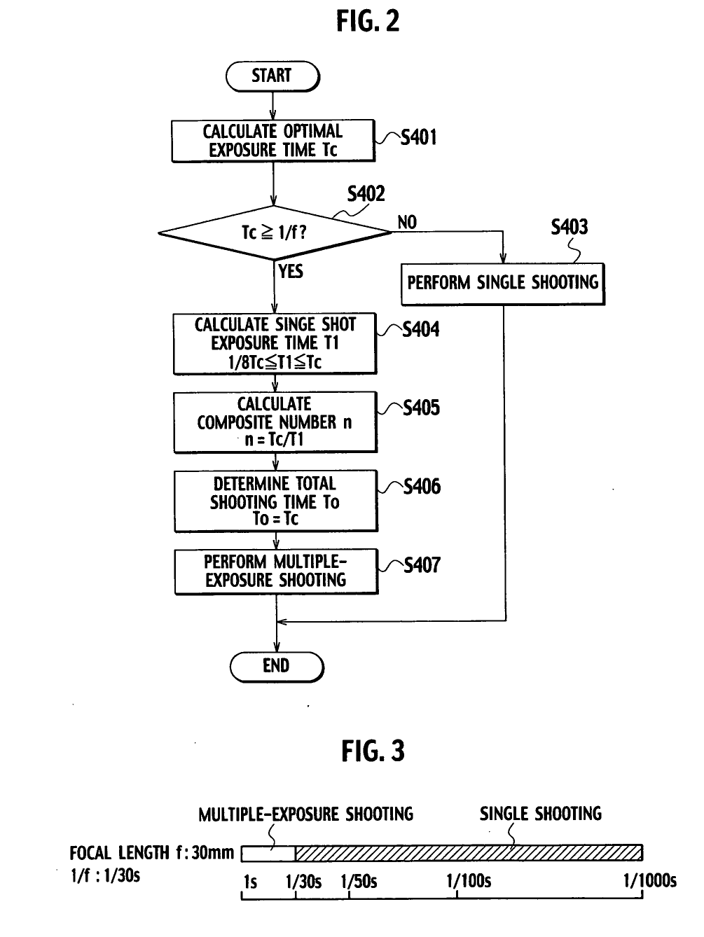

### DETAILED DESCRIPTION OF EMBODIMENTS

### Configuration of an Image Taking Apparatus of the Embodiments

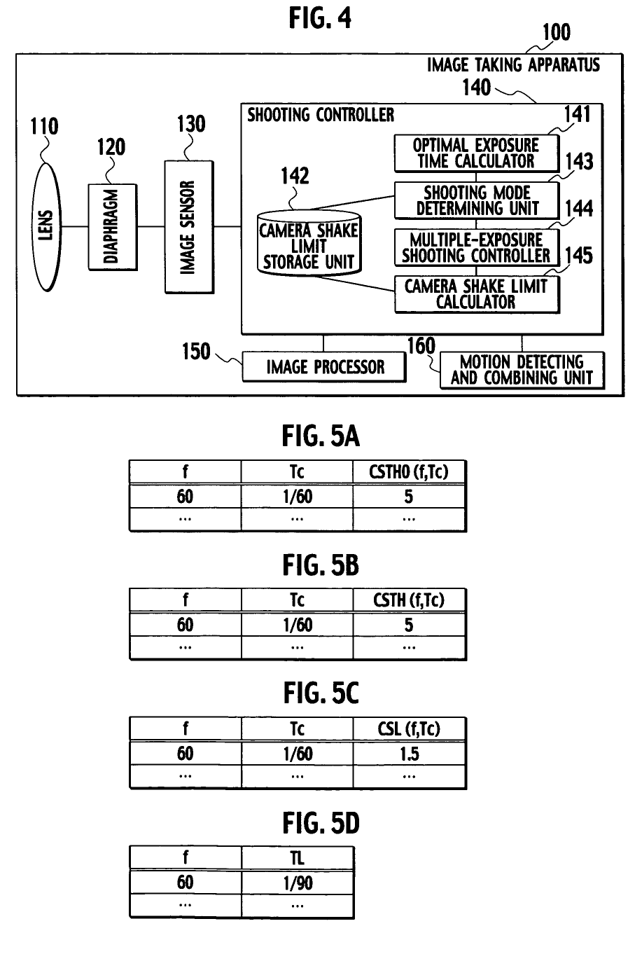

A configuration of an image taking apparatus according to embodiments will be described with reference to FIG. 4 to FIG. 6C. As show in FIG. 4, an image taking apparatus 100 includes a lens 110, an diaphragm 120, image sensor 130, a shooting controller 140, an image processor 150, and a motion detecting and combining unit 160, and is therefore configured to perform multiple-exposure shooting and single shooting. Here, an object image may be any one of a photoelectrically converted image and a shot image.

The photoelectrically converted image is generated by the image sensor 130 exposed through the lens 110 and the diaphragm 120 by means of performing photoelectric conversion, accumulating electric charges, and reading the accumulated electric charges.

Meanwhile, the shot image is obtained by subjecting the photoelectrically converted image to a predetermined process. The predetermined process includes a demosaicing process, a color conversion process, a gradation transformation process, or a Joint Photographic Experts Group (JPEG) compression process, and the like, for example. The image taking apparatus 100 may be a digital still camera or a digital video camera configured to perform still image shooting, for example.

The lens 110 is configured to project light from an object onto the image sensor 130. The diaphragm 120 is configured to adjust an amount of exposure onto the image sensor 130. A degree of aperture of the diaphragm 120 is indicated by an aperture value. The image sensor 130 includes an image pick-up device such as a charge-coupled device (CCD), a complementary metal-oxide semiconductor (CMOS), or the like and is configured to be exposed through the lens 110 and the diaphragm 120, to perform photoelectric conversion, to accumulate electric charges, to read the accumulated electric charges, and thereby to generate the photoelectrically converted image. The frame period Tf indicates the shortest period available for the image sensor 130 from starting the readout of the accumulated electric charges to completing the generation of the photoelectrically converted image.

The shooting controller 140 includes an optimal exposure time calculator 141, a camera shake limit value storage unit 142, a shooting mode determining unit 143, a multiple-exposure shooting controller 144, and a camera shake limit value calculator 145. The optimal exposure time calculator 141 is configured to calculate optimal exposure time Tc based on the aperture value corresponding to the diaphragm 120 and on brightness of the object. Alternatively, the optimal exposure time calculator 141 may be configured to calculate the optimal exposure time Tc based on the aperture value corresponding to the diaphragm 120, the brightness of the object, and ISO sensitivity. Here, the ISO sensitivity is sensitivity that corresponds to a value converted into standards defined by ISO (the International Organization of Standardization) photographic sensitivity standards. In a case where the ISO sensitivity is high, it is possible to take an image in an appropriate exposure condition in spite of the short optimal exposure time Tc and thereby to prevent a camera shake.

The camera shake limit value storage unit 142 is configured to store a table (hereinafter referred to as a reference camera shake threshold table) for storing correlations among a focal length f, the optimal exposure time Tc, and a reference camera shake threshold CSTHO (f, Tc) (to be described later) as shown in FIG. 5A. The camera shake limit value storage unit 142 is also configured to store a table (hereinafter referred to as a camera shake threshold table) for storing correlations among the focal length f, the optimal exposure time Tc, and a camera shake threshold CSTH (f, Tc) (to be described later) as shown in FIG. 5B. The camera shake limit value storage unit 142 is also configured to store a table (hereinafter referred to as a camera shake coefficient table) for storing correlations among the focal length f, the optimal exposure time Tc, and a camera shake coefficient CSL (f, Tc) (to be described later) as shown in FIG. 5C. The camera shake limit value storage unit 142 is also configured to store a table (hereinafter referred to as a camera shake limit value table) for storing correlations between the focal length f and a camera shake limit value TL as shown in FIG. 5D.

Here, the camera shake limit value TL is assigned a predetermined time as a benchmark used for determination to perform the single shooting or the multiple-exposure shooting. The shooting mode determining unit 143 is configured to determine execution of the multiple-exposure shooting in a case where the optimal exposure time Tc is equal to or longer than the camera shake limit value TL. The shooting mode determining unit 143 is configured to make reference to the camera shake limit value table in the camera shake limit value storage unit 142 and to obtain the camera shake limit value TL correlated with the focal length f which is set up at the time of shooting the object. Meanwhile, the shooting mode determining unit 143 may be configured to determine execution of the single shooting in a case where the optimal exposure time Tc is shorter than the camera shake limit value TL.

The multiple-exposure shooting controller 144 is configured to calculate single shot exposure time T1 necessary for obtaining a single shot of the object image, a composite number n of multiple object images necessary for obtaining a composite image, and total shooting time To necessary for obtaining the multiple object images in the multiple-exposure shooting based on the optimal exposure time Tc and the camera shake limit value TL. Moreover, the multiple-exposure shooting controller 144 may be configured to calculate the total shooting time To based on the frame period Tf in a case where the calculated single shot exposure time T1 is shorter than the frame period Tf. Meanwhile, the multiple-exposure shooting controller 144 may be configured to extend the single shot exposure time T1 in the case where the calculated single shot exposure time T1 is shorter than the frame period Tf and the total shooting time To calculated based on the frame period Tf is longer than the optimal exposure time Tc, and to calculate the composite number n and the total shooting time To based on the single shot exposure time T1. Meanwhile, the multiple-exposure shooting controller 144 may be configured to define the optimal exposure time Tc as the total shooting time To in the case where the calculated single shot exposure time T1 is shorter than the frame period Tf and the total shooting time To calculated based on the frame period Tf is longer than the optimal exposure time Tc, and to calculate the single shot exposure time T1 and the composite number n based on the total shooting time To. Meanwhile, the multiple-exposure shooting controller 144 may be configured to calculate the composite number n in the multiple-exposure shooting based on an evaluated value indicating a correction effect of the motion which is detected by the motion detecting and combining unit 160 to be described later.

Here, the motion correction means correction of positions of the multiple object images based on the motion among the multiple object images detected by the motion detecting and combining unit 160 to be described later in order to prevent misalignment of the composite image.

Moreover, the evaluated value (k) showing the correction effect of the motion is an evaluated value which indicates the correction effect of the motion by the stage of the aperture value. For example, in a case where a composite image obtained by correcting the multiple object images (taken at the exposure time= 1/64 second) has image quality similar to an object image (taken at the exposure time=⅛ second), the correction effect is equivalent to three stages of the aperture. In this case, the value k is equal to 3. Meanwhile, the multiple-exposure shooting controller 144 may be configured to calculate the composite number n based on the ISO sensitivity in the multiple-exposure shooting.

The camera shake limit value calculator 145 is configured to calculate the camera shake limit value TL based on the focal length f, and the camera shake coefficient CSL (f, Tc) and to store the camera shake limit value TL in the camera shake limit value table in the camera shake limit value storage unit 142. Moreover, the camera shake limit value calculator 145 is configured to update the camera shake coefficient CSL (f, Tc), which is a predetermined coefficient, based on an amount of motion detected among the multiple object images in the multiple-exposure shooting. To be more specific, the camera shake coefficient CSL (f, Tc) is calculated based on a camera shake pixel number CSPX (f, Tc), a reference camera shake threshold CSTHO (f, Tc), and a camera shake threshold CSTH (f, Tc) with reference to the camera shake limit value storage unit 142, and is updated on the camera shake coefficient table in the camera shake limit value storage unit 142. Here, the camera shake pixel number CSPX (f, Tc) is equivalent to the amount of motion detected in the multiple-exposure shooting by the motion detecting and combining unit 160 to be described later.

The reference camera shake threshold CSTHO (f, Tc) is equivalent to an initial value of the amount of motion regarded as occurrence of a camera shake at the focal length f and at the optimal exposure time Tc which are set up at the time of shooting the object. The camera shake threshold CSTH (f, Tc) is equivalent to the amount of motion regarded as occurrence of a camera shake at the focal length f and at the optimal exposure time Tc which are set up at the time of shooting the object.

Alternatively, the camera shake coefficient CSL (f, Tc) may be updated based on a gain CSGAIN which is a predetermined coefficient used for changing the camera shake coefficient CSL (f, Tc).

The image processor 150 is configured to obtain the shot image by subjecting the photoelectrically converted image, which is obtained by the image sensor 130, to the predetermined process.

To be more specific, the image processor 150 is configured to obtain the shot image by subjecting the photoelectrically converted image to the demosaicing process, the color conversion process, the scale transformation process or the JPEG compression process, and the like.

The motion detecting and combining unit 160 is configured to combine the multiple subject images and to obtain the composite image in the multiple-exposure shooting.

Moreover, the motion detecting and combining unit 160 is configured to detect the motion among the multiple object images in the multiple-exposure shooting and to detect the amount of motion.

Here, the amount of motion (the camera shake pixel number CSPX (f, Tc)) indicates the motion detected among the multiple object images by use of the number of pixels.

For example, the amount of motion (the camera shake pixel number CSPX (f, Tc)) may be defined by a greater number out of a result of comparison between the motion (the number of pixels) in a horizontal direction and the motion (the number of pixels) in a vertical direction.

Meanwhile, the motion detecting and combining unit 160 may be configured to combine the multiple object images by correcting the motion among the multiple object images and thereby to obtain the composite image in the multiple-exposure shooting.

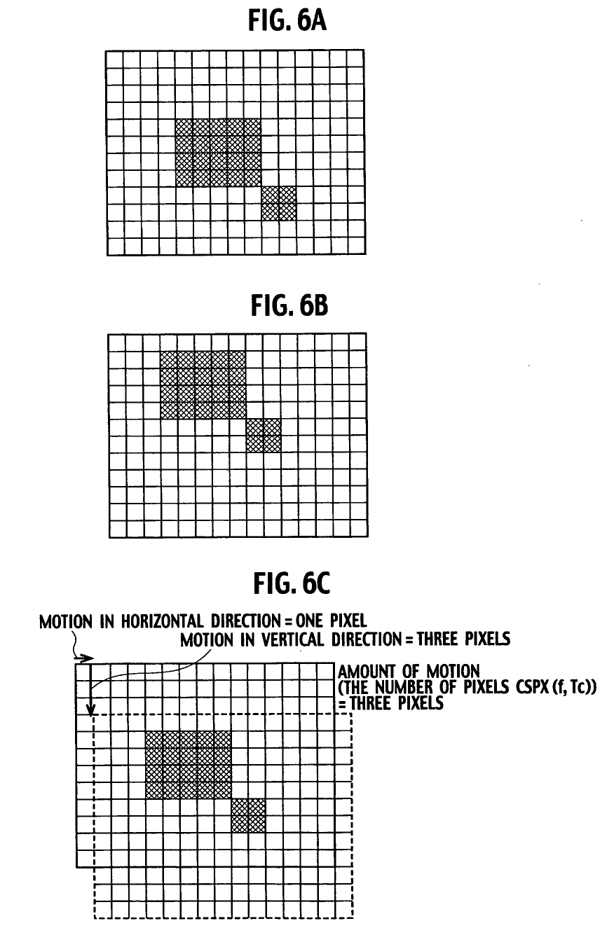

For example, as shown in FIGS. 6A to 6C, the motion detecting and combining unit 160 is configured to obtain object images as shown in FIG. 6A and FIG. 6B in the multiple-exposure shooting, then to combine the two object images by correcting the motion between the two object images, and to obtain a composite image as shown in FIG. 6C.

In this case, the motion detecting and combining unit 160 detects the motion between FIG. 6A and FIG. 6B by use of a publicly-known method such as a feature point extraction method.

In this case, as shown in FIG. 6C, the motion between the object images of FIG. 6A and FIG. 6B in the horizontal direction is equivalent to 1 pixel, while the motion in the vertical direction therebetween is equivalent to 3 pixels. Accordingly, the camera shake pixel number CSPX (f, Tc) is equal to 3 pixels.

### Operations of the Image Taking Apparatus of the Embodiments

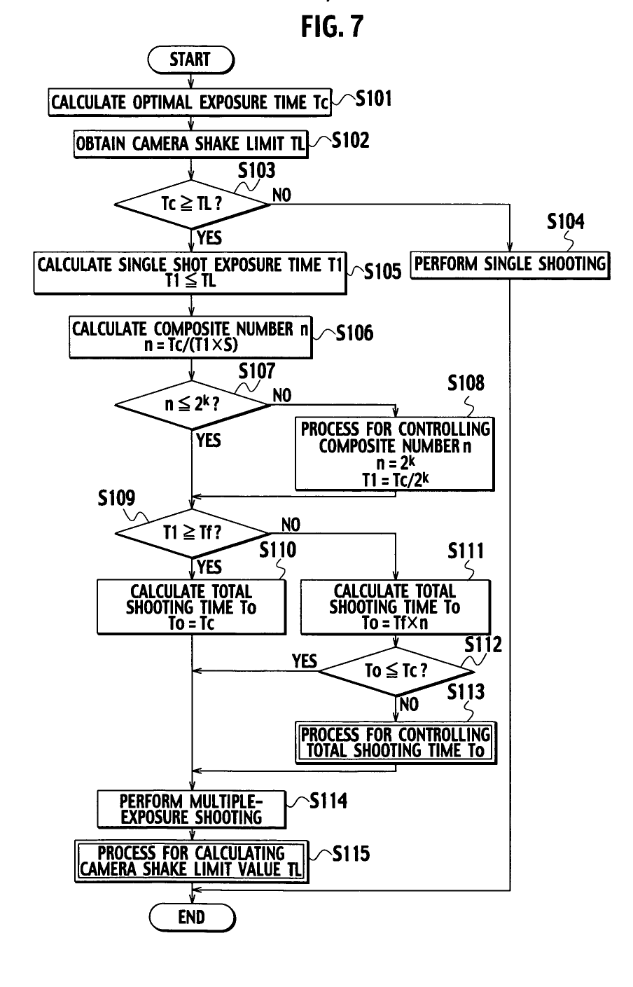

Next, operations of the image taking apparatus according to the embodiment of the present invention will be described below with reference to FIG. 7 to FIG. 9.

FIG. 7 is a flowchart showing an operation performing the single shooting or the multiple-exposure shooting of the image taking apparatus 100 of the embodiments.

As shown in FIG. 7, in Step S101, the optimal exposure time calculation unit 141 calculates the optimal exposure time Tc based on the aperture value corresponding to the diaphragm 120 and on the brightness of the object.

In Step S102, the shooting mode determining unit 143 makes reference to the camera shake limit value table in the camera shake limit value storage unit 142, and obtains the camera shake limit value TL correlated with the focal length f which is set up at the time of shooting the object.

In Step S103, the shooting mode determining unit 143 determines whether the single shooting is performed or the multiple-exposure shooting is performed by use of the camera shake limit value TL as the benchmark.

To be more specific, in the case where the optimal exposure time Tc is shorter than the camera shake limit value TL, the shooting mode determining unit 143 determines execution of the single shooting and the operation proceeds to Step S104. In the case where the optimal exposure time Tc is equal to or longer than the camera shake limit value TL, the shooting mode determining unit 143 determines execution of the multiple-exposure shooting and the operation proceeds to Step S105.

In Step S104, the image taking apparatus 100 performs a single shooting. In Step S105, the multiple-exposure shooting controller 144 calculates the single shot exposure time T1 necessary for obtaining a single object image in the multiple-exposure shooting. To be more specific, the single shot exposure time T1 is set equal to or shorter than the camera shake lime value TL.

In Step S106, the multiple-exposure shooting controller 144 calculates the composite number n of the multiple object images necessary for obtaining the composite image in the multiple-exposure shooting. For example, the composite number n is calculated by use of “composite number n=optimal exposure time (Tc)/(single shot exposure time T1×S).”

Here, the parameter S in the above-mentioned formula denotes a gain (sensitivity) for determining the ISO sensitivity. The ISO sensitivity is increased in a case where the gain for determining the ISO sensitivity becomes greater. In the above-described formula, the composite number n is decreased as a consequence.

In Step S107, the multiple-exposure shooting controller 144 compares the composite number n with an upper limit value of the composite number n.

For example, the upper limit value of the composite number n may be defined as 2^{k} by use of the above-described evaluated value k indicating the correction effect.

In a case where the composite number n is equal to or below the upper limit value, the operation proceeds to Step S109. In a case where the composite number n is greater than the upper limit value, the operation proceeds to Step S108.

In Step S108, the multiple-exposure shooting controller 144 performs a suppression process for the composite number n, and then calculates the composite number n and the single shot exposure time T1 again.

To be more specific, the composite number n is calculated by use of “composite number n=2^{k}.” The single shot exposure time T1 is calculated by use of “single shot exposure time T1=optimal exposure time Tc/2^{k}.”

In Step S109, the multiple-exposure shooting controller 144 compares the single shot exposure time T1 with the frame period Tf.

In the case where the single shot exposure time T1 is equal to or longer than the frame period Tf, the operation proceeds to Step S110. In a case where the single shot exposure time T1 is shorter than the frame period Tf, the operation proceeds to Step S111.

In Step S110, the multiple-exposure shooting controller 144 calculates the total shooting time To necessary for obtaining the multiple object images in the multiple-exposure shooting. To be more specific, the total shooting time To is calculated by use of “total shooting time To=single shot exposure time T1×composite number n,” which is equal to the optimal exposure time Tc.

In Step S111, the multiple-exposure shooting controller 144 calculates the total shooting time To based on the frame period Tf. To be more specific, the total shooting time To is calculated by use of “total shooting time To=frame period Tf×composite number n.”

In Step S112, the multiple-exposure shooting controller 144 compares the total shooting time To calculated in Step S111 with the optimal exposure time Tc.

In the case where the total shooting time To is equal to or below the optimal exposure time Tc, the operation proceeds to Step S114. In the case where the total shooting time To is shorter than the optimal exposure time Tc, the operation proceeds to Step S113.

In Step S113, the multiple-exposure shooting controller 144 performs a suppression process for the total shooting time To. Details of the process are as follows.

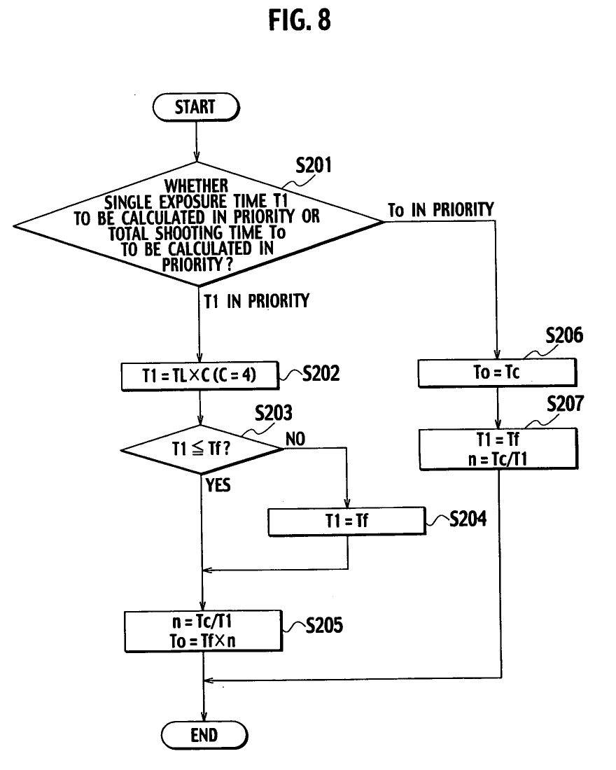

FIG. 8 is a flowchart showing the suppression process for the total shooting time To in this embodiment.

As shown in FIG. 8, in Step S201, the multiple-exposure shooting controller 144 determines whether the single shot exposure time T1 is calculated in priority or the total shooting time To is calculated in priority.

In a case where the multiple-exposure shooting controller 144 calculates the single shot exposure time T1 and then calculates the composite number n and the total shooting time To based on the single shot exposure time T1, the operation proceeds to Step S202. In the case where the multiple-exposure shooting controller 144 calculates the total shooting time To and then calculates the single shot exposure time T1 and the composite number n based on the total shooting time To, the operation proceeds to Step S206.

In Step S202, the multiple-exposure shooting controller 144 extends the single shot exposure time T1.

To be more specific, the single shot exposure time T1 is calculated by use of “single shot exposure time T1=camera shake limit value TL×coefficient C.”

The coefficient C is a coefficient used for extending the single shot exposure time T1 and thereby suppressing the total shooting time To to be close to the optimal exposure time Tc. The coefficient C may be set equal to 4, for example.

In Step S203, the multiple-exposure shooting controller 144 compares the single shot exposure time T1 calculated in Step S202 with the frame period Tf.

In the case where the single shot exposure time T1 is equal to or shorter than the frame period Tf, the operation proceeds to Step S205. In the case where the single shot exposure time T1 is longer than the frame period Tf, the operation proceeds to Step S204.

In Step S204, the multiple-exposure shooting controller 144 defines “single shot exposure time T1=frame period Tf.”

In Step S205, the multiple-exposure shooting controller 144 calculates the composite number n and the total shooting time To based on the recalculated single shot exposure time T1.

To be more specific, the composite number n is calculated by use of “composite number n=optimal exposure time Tc×single shot exposure time T1.” The total shooting time To is calculated by use of “total shooting time To=frame period Tf×composite number n.”

In Step S206, the multiple-exposure shooting controller 144 defines “total shooting time To=optimal exposure time Tc.”

In Step S207, the multiple-exposure shooting controller 144 calculates the single shot exposure time T1 and the composite number n based on the recalculated total shooting time To.

To be more specific, the single shot exposure time T1 is defined as “single shot exposure time T1=frame period Tf” The composite number n is calculated by use of “composite number n=optimal exposure time Tc/single exposure time T1.”

In Step S114 in FIG. 7, the image taking apparatus 100 performs the multiple-exposure shooting in accordance with the calculated single shot exposure time T1, the composite number n, and the total shooting time To.

In Step S115, the camera shake limit value calculator 145 performs a process for calculating the camera shake limit value TL. Details of the process are as follows.

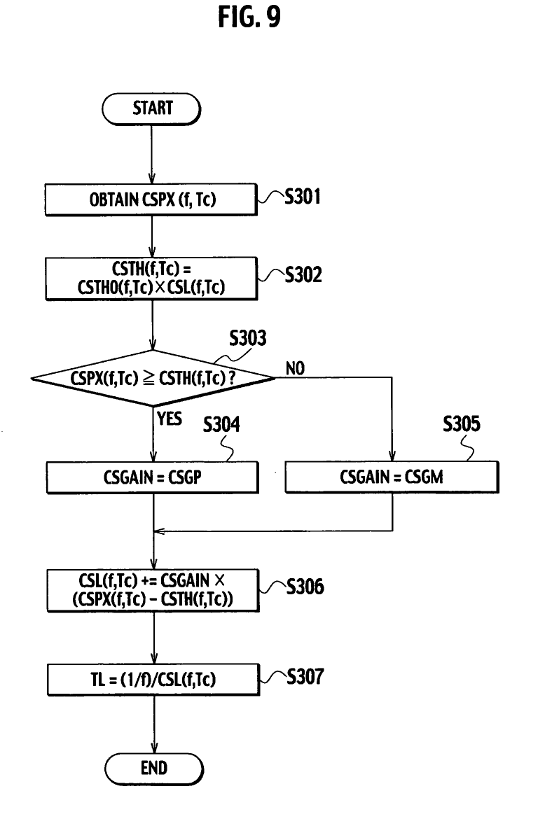

FIG. 9 is a flowchart showing a calculation process for the camera shake limit value TL in this embodiment.

As shown in FIG. 9, in Step S301, the camera shake limit value calculator 145 obtains the camera shake pixel number CSPX (f, Tc) which is the amount of motion detected by the motion detecting and combining unit 160.

In Step S302, the camera shake limit value calculator 145 makes reference to the reference camera shake threshold table in the camera shake limit value storage unit 142, and obtains the reference camera shake threshold CSTHO (f, Tc) correlated with the focal length f and the optimal exposure time Tc.

Furthermore, the camera shake limit value calculator 145 makes reference to the reference camera shake coefficient table in the camera shake limit value storage unit 142, and obtains the reference camera shake coefficient CSL (f, Tc) correlated with the focal length f and the optimal exposure time Tc.

Moreover, the camera shake limit value calculator 145 calculates the camera shake threshold CSTH (f, Tc) and stores the correlation among the focal length f, the optimal exposure time Tc, and the calculated camera shake threshold CSTH (f, Tc) in the camera shake threshold table in the camera shake limit value storage unit 142.

To be more specific, the camera shake threshold CSTH (f, Tc) is calculated by use of “camera shake threshold CSTH (f, Tc)=reference camera shake threshold CSTHO (f, Tc)×camera shake coefficient CSL (f, Tc).”In Step S303, the camera shake limit value calculator 145 compares the camera shake pixel number CSPX (f, Tc) with the camera shake threshold CSTH (f, Tc).

In a case where the camera shake pixel number CSPX (f, Tc) is equal to or greater than the camera shake threshold CSTH (f, Tc), the operation proceeds to Step S304. In a case where the camera shake pixel number CSPX (f, Tc) is less than the camera shake threshold CSTH (f, Tc), the operation proceeds to Step S305.

In Step S304, the camera shake limit value calculator 145 sets CSGP which is a positive number to the gain CSGAIN.

In Step S305, the camera shake limit value calculator 145 sets CSMP which is a positive number to the gain CSGAIN.

Here, the gain CSGAIN is a predetermined coefficient for adjusting the camera shake coefficient CSL (f, Tc). For example, the CSGP may be set greater than the CSMP.

In Step S306, the camera shake limit value calculator 145 calculates the camera shake coefficient CSL (f, Tc) and updates the camera shake coefficient table in the camera shake limit value storage unit 142 with the correlation among the focal length f, the optimal exposure time Tc, and the camera shake coefficient CSL (f, Tc).

To be more specific, the camera shake coefficient CSL (f, Tc) is calculated by use of “camera shake coefficient CSL (f, Tc)=gain CSGAIN×{camera shake pixel number CSPX (f, Tc)−camera shake threshold (f, Tc)}.”

By using the above-described formula, the camera shake limit value calculator 145 can increase and decrease the camera shake coefficient CSL (f, Tc) in response to the difference between the camera shake pixel number CSPX (f, Tc) and the number of pixels at the camera shake threshold CSTH (f, Tc).

Here, the initial value of the camera shake coefficient CSL (f, Tc) is equal to 1.0.

In Step S307, the camera shake limit value calculator 145 calculates the camera shake limit value TL and stores the correlation between the focal length f and the camera shake limit value TL in the camera shake limit value table in the camera shale limit value storage unit 142.

To be more specific, the camera shake limit value TL is calculated by use of “camera shake limit value TL=(1/f)/camera shake coefficient CSL (f, Tc).”

Next, an example of the process for calculating the camera shake limit value TL shown in FIG. 9 will be described.

In the following, the focal length will be expressed as f, the reference camera shake threshold will be expressed as CSTHO (f, Tc), the camera shake threshold will be expressed as CSTH (f, Tc), the camera shake coefficient will be expressed as CSL (f, Tc), the camera shake pixel number will be expressed as CSPX (f, Tc), and the gain will be expressed as CSGAIN.

In a case where f is equal to 60 mm, Tc is equal to 1/60 second, CSTHO (60, 1/60) is equal to 5 pixels, CSL (60, 1/60) is equal to 1.0, and TL is equal to 1/60 second, CSPX (60, 1/60) calculated by the motion detection is assumed to be equal to 10 pixels, for example.

In this case, in Step S302, CSTH (60, 1/60) is calculated as 5×1.0=5 (pixels).

In Step S303, CSPX (60, 1/60)=10 is greater than CSTH (60, 1/60)=5. Accordingly, CSGP=0.1 is set to CSGAIN in Step S304, for example.

In Step S306, CSL (60, 1/60) is calculated as 1.0+0.1×(10·5)=1.5.

In Step S307, TL is calculated as ( 1/60)/1.5= 1/90.

As a result, when CSL (60, 1/60) is updated from 1.0 to 1.5, the camera shake limit value TL is changed from 1/60 (second) to 1/90 (second). Thus, in the next shooting, the multiple-exposure shooting is performed in a case where the optimal exposure time Tc is equal to or longer than 1/90 second.

By repeating the above-described operation, the camera shake limit value TL converges on the exposure time with which the user causes a camera shake.

### Comparison Between the Conventional Image Taking Apparatus and the Image Taking Apparatus of the Embodiment

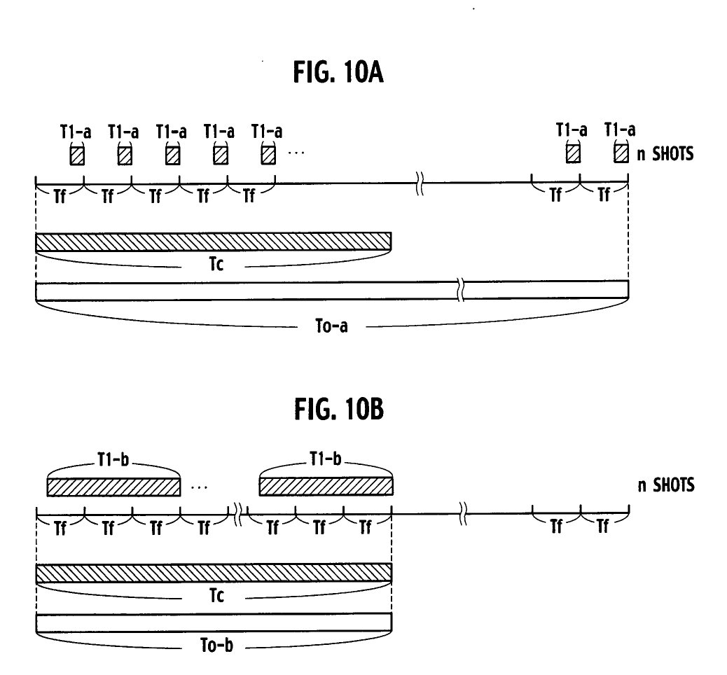

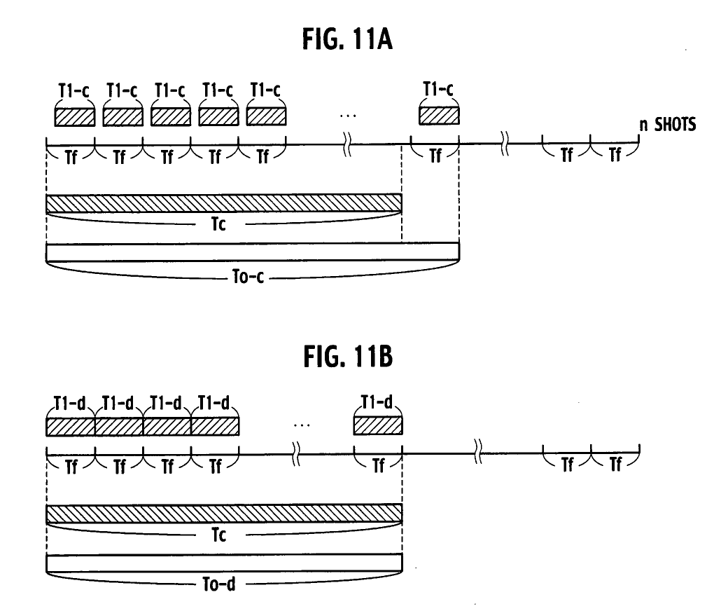

Now, an effect of preventing a camera shake at the time of the multiple-exposure shooting will be described by way of comparison between the conventional image taking apparatus and the image taking apparatus according to the embodiment of the present invention with reference to FIG. 10A to FIG. 11B.

In the following, the single shot exposure time T1 will be expressed as T1-a (second), T1-b (second), T1-c (second), and T1-d (second). The frame period Tf will be expressed as Tf (second). The optimal exposure time Tc will be expressed as Tc (second). The total shooting time To will be expressed as To-a (second), To-b (second), To-c (second), and To-d (second). The composite number n will be expressed as n (shots).

FIGS. 10A and 10B are diagrams showing the multiple-exposure shooting by use of the conventional image taking apparatus.

As shown in FIG. 10A, in the conventional image taking apparatus, the total shooting time To-a is extended in the multiple-exposure shooting in the case where the single shot exposure time T1-a is shorter than the frame period Tf.

In this case, the total shooting time To-a becomes extremely longer than the optimal exposure time Tc. Accordingly, a camera shake is apt to occur.

As shown in FIG. 10B, in the case of the conventional image taking apparatus, the single shot exposure time T1-b is extended when suppressing the total shooting time To-b.

In this case, a camera shake is apt to occur because the single shot exposure time T1-b is extended.

FIG. 11A and 11B are diagrams showing the multiple-exposure shooting by use of the image taking apparatus according to the embodiment of the present invention.

In the case of the image taking apparatus according to the embodiment of the present invention, in a case where the single shot exposure time T1-c and the single shot exposure time T1-d are shorter than the frame period Tf and the total shooting time To-c and the total shooting time To-d are longer than the optimal exposure time Tc, the total shooting time To-c and the total shooting time To-d is controlled as described below.

As shown in FIG. 11A, in a case where the single shot exposure time T1-c is calculated in priority, the single shot exposure time T1-c does not become too long and the total shooting time To-c is also suppressed.

In this case, it is possible to prevent a camera shake because the single shot exposure time T1-c is short. Moreover, the camera shake hardly occurs because the total shooting time To-c is also very short as compared to the total shooting time To-a in the case of the conventional image taking apparatus as shown in FIG. 10A.

Meanwhile, as shown in FIG. 11B, the total shooting time To-d becomes equal to the optimal exposure time Tc in a case where the total shooting time To-d is calculated in priority.

In this case, a camera shake hardly occurs because the total shooting time To-d is suppressed. Moreover, the camera shake hardly occurs because the single shot exposure time T1-d is also very short as compared to the single shot exposure time T1-b in the case of the conventional image taking apparatus as shown in FIG. 10B

### Acts and Effects of the Image Taking Apparatus of the Embodiments

According to the image taking apparatus of this embodiment, it is possible to change the camera shake limit value TL for switching the single shooting to the multiple-exposure shooting every time of the multiple-exposure shooting based on the motion among the multiple object images (the camera shake). It is, therefore, possible to switch the single shooting to the multiple-exposure shooting flexibly in response to occurrence of the camera shake.

According to the image taking apparatus of this embodiment, it is possible to restrict the composite number n by calculating the upper limit value of the composite number n. It is, therefore, possible to prevent degradation of image quality of the composite image attributable to an increase in the composite number n.

According to the image taking apparatus of this embodiment, even in the case where the single shot exposure time T1 is shorter than the frame period Tf in the multiple-exposure shooting, it is possible to prevent a camera shake attributable to the long single shot exposure time T1 by calculating the singe shot exposure time T1 so as not to be too long while suppressing the total shooting time To.

According to the image taking apparatus of this embodiment, the total shooting time To can be suppressed even in the case where the single shot exposure time T1 is shorter than the frame period Tf in the multiple-exposure shooting. It is, therefore, possible to prevent a camera shake attributable to the long total shooting time To.

While the present invention has been described with reference to the aforementioned embodiment, it is to be understood that the description and the drawings constituting part of this disclosure shall not limit the scope of this invention. It is obvious to those skilled in the art that various substitute embodiments, examples, and application techniques are possible from the teachings of this specification.

It is therefore needless to say that the present invention encompasses various other embodiments not expressly stated herein. In this context, the technical scope of the present invention shall be solely determined by the matters to define the invention, which will be appropriately defined by the appended claims.

What is claimed is:

1. An image taking apparatus performing a multiple-exposure shooting by using object images, the image taking apparatus comprising:
a lens;
a diaphragm;
an image sensor configured to obtain object images through the lens and the diaphragm;
an exposure time calculator configured to calculate exposure time of the image sensor based on an aperture value corresponding to the diaphragm and on brightness of the object;
a predetermined time calculator configured to calculate predetermined time based on a focal length of the lens and a predetermined coefficient;
a shooting mode determining unit configured to determine execution of the multiple-exposure shooting to obtain a composite image of the object if the exposure time is equal to or longer than the predetermined time, said composite image obtained to combine the plurality of object images;
a motion detector configured to detect motion among the plurality of object images in the multiple-exposure shooting; and
a predetermined coefficient calculator configured to update the predetermined coefficient based on the detected amount of motion.

2. The image taking apparatus according to claim 1, further comprising:
a multiple-exposure shooting controller configured to calculate single shot exposure time necessary for obtaining one object image, a composite number of the plurality of object images necessary for obtaining the composite image, and total shooting time necessary for obtaining the plurality of object images, based on the exposure time and the predetermined time in the multiple-exposure shooting.

3. The image taking apparatus according to claim 2,
wherein the multiple-exposure shooting controller calculates an upper limit value of the composite number by use of an evaluated value indicating a correction effect of the motion and calculates the composite number based on the upper limit value.

4. The image taking apparatus according to claims 2,
wherein, in a case where the single shot exposure time is shorter than a frame period, the multiple-exposure shooting controller calculates the total shooting time based on the frame period.

5. The image taking apparatus according to one of claims 3,
wherein, in a case where the single shot exposure time is shorter than a frame period, the multiple-exposure shooting controller calculates the total shooting time based on the frame period.

6. The image taking apparatus according to claim 4,
wherein the multiple-exposure shooting controller extends the single shot exposure time in the case where the single shot exposure time is shorter than the frame period and the total shooting time calculated based on the frame period is longer than the exposure time, and calculates the composite number and the total shooting time based on the single shot exposure time.

7. The image taking apparatus according to claim 4,
wherein the multiple-exposure shooting controller defines the exposure time as the total shooting time in the case where the single shot exposure time is shorter than the frame period and the total shooting time calculated based on the frame period is longer than the exposure time, and calculates the single shot exposure time and the composite number based on the total shooting time.

8. A program for obtaining an object image by use of image sensor exposed through a lens and a diaphragm and to perform a multiple-exposure shooting by use of the object image, the program causing a computer to execute procedures for:
calculating exposure time of the image sensor based on an aperture value corresponding to the diaphragm and on brightness of the object;
calculating predetermined time based on a focal length of the lens and a predetermined coefficient;
determining execution of the multiple-exposure shooting to obtain a composite image of the object if the exposure time is equal to or longer than the predetermined time, said composite image obtained to combine the plurality of object images;
detecting motion among the plurality of object images in the multiple-exposure shooting; and
updating the predetermined coefficient based on a detected amount of motion.

9. The program according to claim 8, further causing a computer to execute procedures for:
calculating single shot exposure time necessary for obtaining one object image, a composite number of the plurality of object images necessary for obtaining the composite image, and total shooting time necessary for obtaining the plurality of object images, based on the exposure time and the predetermined time in the multiple-exposure shooting.

10. The program according to claim 9, further causing a computer to execute procedures for:
calculating an upper limit value of the composite number by use of an evaluated value indicating a correction effect of the motion and calculates the composite number based on the upper limit value.

11. The program according to claims 9, further causing a computer to execute procedures for:
calculating the total shooting time based on the frame period in a case where the single shot exposure time is shorter than a frame period.

12. The program according to claims 10, causing a computer to execute procedures for:
calculating the total shooting time based on the frame period in a case where the single shot exposure time is shorter than a frame period.

13. The program according to claim 11, causing a computer to execute procedures for:
extending the single shot exposure time if the single shot exposure time is shorter than the frame period and the total shooting time calculated based on the frame period is longer than the exposure time, and calculates the composite number and the total shooting time based on the single shot exposure time,

14. The program according to claim 11, causing a computer to execute procedures for:
defining the exposure time as the total shooting time in the case where the single shot exposure time is shorter than the frame period and the total shooting time calculated based on the frame period is longer than the exposure time, and calculates the single shot exposure time and the composite number based on the total shooting time.
